(19) United States
(12) Patent Application Publication
(10) Pub. No.: US 2009/0089168 A1
(43) Pub. Date: Apr. 2, 2009

(54) ACE (Alternative Currency Exchange): Alternative Currency Tracking and Mapping System and Method

(76) Inventor: Phyllis Adele Schneck, Atlanta, GA (US)

Correspondence Address: Dr. Phyllis A. Schneck, 3221 Gables Way, Atlanta, GA, 30329, US

(21) Appl. No.: 11/970,494

(22) Filed: Jan. 7, 2008

Related U.S. Application Data
(60) Provisional application No. 60/884,339, filed on Jan. 10, 2007.

(51) Int. Cl. G06Q 40/00; G06Q 30/00

(52) U.S. Cl. 705/14; 705/37

(57) ABSTRACT

The invention being disclosed relates to mapping alternative currencies to known worldwide currencies/cash (e.g. dollars, Euros), creating a computation engine to determine the relative values among real and alternative currencies, providing a service and exchange for maintaining or providing an orderly change in the relative value (exchange rate) of alternative and real currencies, and enabling the trading.

The invention includes a system and method to map alternative currencies to known currencies/cash (e.g. dollars, Euros).

Alternative currencies include but are not limited to:
Airline rewards (such as miles, points)
Hotel rewards (such as miles, points)
Credit card points, rewards
Cash accumulated within “virtual environments” such as online games (e.g. “Second Life”)

A rate quotation will be provided by computing the number of units of alternative currency that are equivalent to known currency.

The invention being disclosed relates to mapping alternative currencies to known worldwide currencies/cash (e.g. dollars, Euros), creating a computation engine to determine the relative values among real and alternative currencies, providing a service and exchange for maintaining or providing an orderly change in the relative value (exchange rate) of alternative and real currencies, and enabling the trading.

System to map alternative currencies to known currencies/cash (e.g. dollars, Euros).

Alternative currencies include but are not limited to:
Airline rewards (such as miles, points)
Hotel rewards (such as miles, points)
Credit card points, rewards
Cash accumulated within “virtual environments” such as online games (e.g. “Second Life”)

A rate quotation will be provided by computing the number of units of alternative currency that are equivalent to known currency, For example, $20 accumulated in the “Second Life” game may be equivalent to X United States dollars. A user can go to the website where the exchange rate is displayed and receive cash or trade the alternative currency for other alternative currencies based on their exchange rates (e.g. Q Second Life dollars may be equivalent to R Delta Skymiles).

Values put on the alternative currency by the provider of the alternative currency (e.g. Delta Air Lines permits the purchase of Skymiles with a certain number of dollars, therefore identifying a “cost” (aka exchange rate) for Skymile-dollars.

Rate fluctuations may occur based on a variety of factors:
Vendor rule changes (e.g. airlines change reward policy rules)
Market changes within virtual environments
True market changes (value changes in real currencies worldwide)
Supply and demand
Etc.

### Rate Computation Engine

The underlying rate computation engine is analogous to the engine beyond a standard currency exchange, computing relative values of each currency based on trading volumes, and market drivers and the drivers listed above, for example computing relative values based on the balance of buyers and sellers, as is the case at a stock exchange.

The computation engine may also take into account parameters such as the cost of earning the alternative currencies as well as or compared to the real-world or perceived actual price of the rewards offered by various virtual environments, businesses and retailers in exchange for the alternative currencies.

Further, the computation engine can produce a price number or vector, looking at some or all possible parameters such as combinations of alternative currencies and the value of the combinations vs just one currency (e.g. combining X Hilton points and Y Delta Skymiles may be less lucrative than (X+Y) Delta Skymiles.

The computation engine includes as many inputs and/or input parameters as necessary to receive real-time updates of vendor/retail promotions on acquisition, redemption or value of their alternative currencies (such as Second Life environment or gaming environment dollar values).

Functionality of Web User Interface or other GUI or any General User Interface

### View Information—No Login Required:

Display exchange rate for each currency in a N×N or N×M matrix or other presentation and/or chart.

### Make Transaction: Authenticated Login Required:

Provide appropriate (equivalent to financial transaction and retail sales websites e.g. eBay or Fidelity) transactions (can be but not limited to as per FFIEC and other Federal/local government and financial regulations).

GUI can demonstrate live or near-real-time (or past) pictures of the input and output of the computation engine, any and all perceived values for all currencies, retail offers, and any parameter within the computation engine.

### Revenue Model for Service

Can include one or more of the following:
Percent of each trade and/or fixed cost per trade
Advertising on site
Use of OWOXX or ACE/alternative currency exchange trademarked name by vendors in their advertising
Vendors (e.g. Delta, Second Life) may pay to be listed

What is claimed is:

1. A computer implemented method, comprising: accessing exchange rates for various entities, such as airline points/“miles”, hotel points, or virtual gaming currency such as “Second Life”/Linden dollars; displaying those values if desired via web, printed, audio, visual, or other modes; providing a list of options for a user to choose, such list including exchanging one entity's currency for another entity's currency, and
effecting the choice made by the user.

2. A computer implemented method, comprising: accessing exchange rates for various entities such as airline points/“miles”, hotel points, or virtual gaming currency such as “Second Life”/Linden dollars;
displaying those values if desired via web, printed, audio, visual, or other modes;
providing comparison of values of each, either or both historical, estimated, or real-time;
providing a list of options for a user to choose, such list including exchanging one entity's currency for another entity's currency, and effecting the choice made by the user.

3. The method of claim 1, wherein the currency is both virtual environment and “reward points” from a company

4. The method of claim 1, wherein the currency is “reward points” from a company

5. The method of claim 1, wherein the currency is currency in a virtual environment

6. The method of claim 1, wherein the user requests a specific combination of each currency and the method provides exchange options based on the user's choice

7. A computer system that provides to a user exchange rates for various entities, such as airline points/“miles”, hotel points, or virtual gaming currency such as “Second Life”/Linden dollars;
that displays at least one of those values;
that provides a list of options for a user to choose, such list including exchanging one entity's currency for another entity's currency, and that effects the choice made by the user.
